(19) United States
(12) Patent Application Publication
(10) Pub. No.: US 2014/0352986 A1
(43) Pub. Date: Dec. 4, 2014

(54) THERMAL CIRCULATING FIRE PREVENTION SPRINKLER SYSTEM

(71) Applicant: The Reliable Automatic Sprinkler Co., Inc., Liberty, SC (US)

(72) Inventors: Thomas Multer, Liberty, SC (US); Mark Coad, Liberty, SC (US); Robert Gottermeier, Liberty, SC (US); Myron Allen, Liberty, SC (US)

(73) Assignee: THE RELIABLE AUTOMATIC SPRINKLER CO., INC., Liberty, SC (US)

(21) Appl. No.: 14/360,281

(22) PCT Filed: Nov. 23, 2012
(86) PCT No.: PCT/US12/66456

§ 371 Date: May 22, 2014

Related U.S. Application Data
(60) Provisional application No. 61/563,118, filed on Nov. 23, 2011.

(51) Int. Cl. A62C 35/68; F28F 1/00; A62C 35/60

(52) U.S. Cl. CPC A62C 35/68; A62C 35/60; F28F 1/00
USPC 169/16

(57) ABSTRACT

A fire prevention sprinkler system that has a warming jacket through which a warming medium, preferably water, is circulated, at a temperature sufficient to prevent freezing of those portions of the sprinkler system that contain water or another freezable liquid at times when the sprinklers are not actually spraying water to control or extinguish a fire. The warming medium is preferably heated by radiant heating, and circulation is preferably initiated by a thermostatic control whenever the temperature in the protected premises drops below a predetermined value.

### RELATED APPLICATION

This application claims benefit under 35 U.S.C. §119(e) of provisional A.N. 61/563,118, filed Nov. 23, 2011, the entire contents of which are incorporated herein by reference.

### BACKGROUND

1. Technical Field

This disclosure relates generally to fire prevention sprinkler systems, and more particularly to a fire prevention sprinkler system that can prevent freezing of the system even during cold weather. It further relates to a fluid-distribution system to supply a fluid to a system of fire-prevention sprinklers to prevent freezing thereof.

2. Description of Related Art

Freezing weather is a danger to fire prevention sprinklers, as to other plumbing systems, if water is present in the sprinklers or associated piping and is allowed to freeze. When the sprinklers and associated piping are located in premises that are kept above freezing temperature at all times, this is not a problem.

Where the sprinklers must provide protection for unheated premises, such as some warehouses, loading docks, concealed spaces, or attics, it is not economical to heat the premises just to protect the sprinkler system. One common approach to solving that problem is to retain the water in a portion of the piping system that is in a heated area, and to maintain the sprinklers themselves dry except when in actual operation applying water. These “dry” sprinklers are expensive, and the water in the system piping must remain above freezing temperatures.

Another method for sprinkler protection in freezing conditions is to use a dry pipe sprinkler system. This system uses an air compressor or nitrogen to fill the sprinkler system piping. The sprinklers must be of the dry type. When a sprinkler operates, a control valve opens and allows water to flow into the piping system and discharge from the now-open sprinkler or sprinklers. There is a time delay in providing water application to the fire, which must be determined and taken into account to provide proper fire protection. Such a system requires special installation to prevent trapping of water in the piping system and the equipment, and dry sprinklers are very expensive in comparison to a standard wet pipe sprinkler system.

Another method is to fill the sprinkler system piping with a mixture of water and an antifreeze solution. Recent studies have shown, however, that high percentages of antifreeze can cause actually be dangerous to occupants in the fire area. This is also a relatively expensive method of providing freeze protection due to the cost of materials, and inspection and maintenance requirements.

All of these methods are impractical for certain types of premises, and they each add a significant cost to provide freeze protection to a fire sprinkler system.

### SUMMARY

It is desired to provide a fire prevention sprinkler piping system that can prevent freezing even when used at low temperatures. It is also desired to provide a fluid-distribution system that can distribute a heated fluid to a fire prevention sprinkler system to prevent freezing.

Some embodiments disclosed herein may utilize an active heat source or generator to provide heat to warm the warming medium fluid. In particular, some embodiments may utilize a radiant heating system to heat the warming medium.

Other sources of heat to warm the medium can be used, examples including water heaters, geo-thermal devices, boilers, and other heat transfer equipment.

A passive heating system may be used in some embodiments.

### BRIEF DESCRIPTION OF THE DRAWING FIGURES

FIG. 1 is a diagram illustrating schematically the arrangement of elements in one embodiment.

FIGS. 2A and 2B illustrate schematically two alternative arrangements that may be used in the embodiment of FIG. 1.

FIG. 3 is a diagram illustrating schematically the arrangement of elements in another embodiment.

FIG. 4 is a diagram further illustrating the arrangement of elements in the embodiment of FIG. 3.

### DETAILED DESCRIPTION OF THE PREFERRED EMBODIMENTS

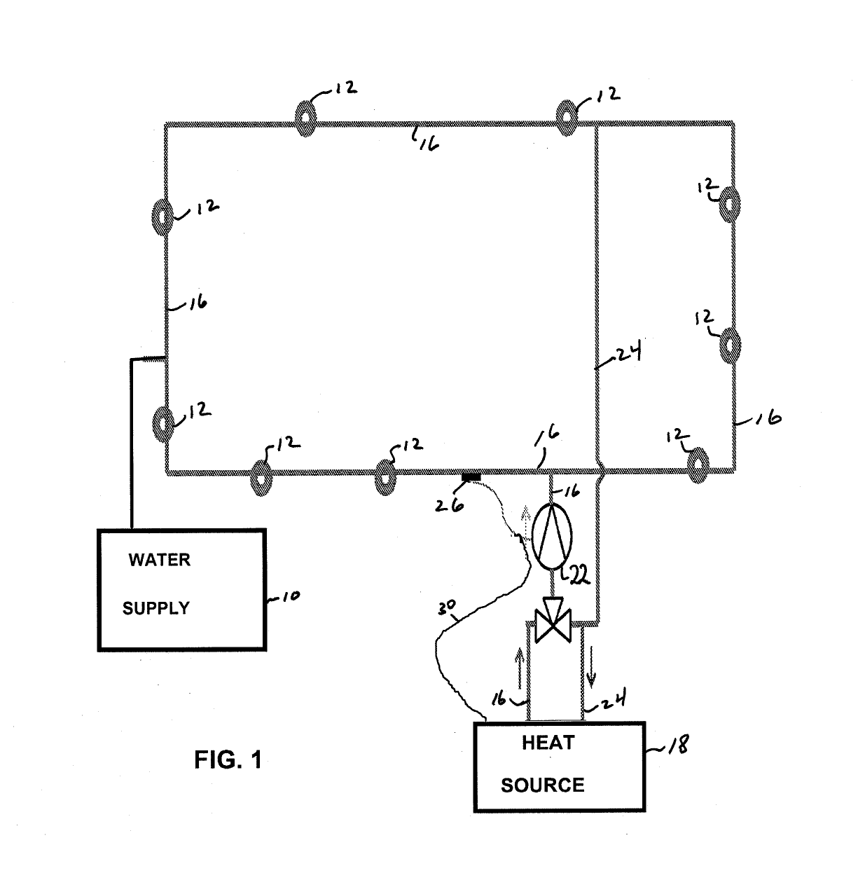

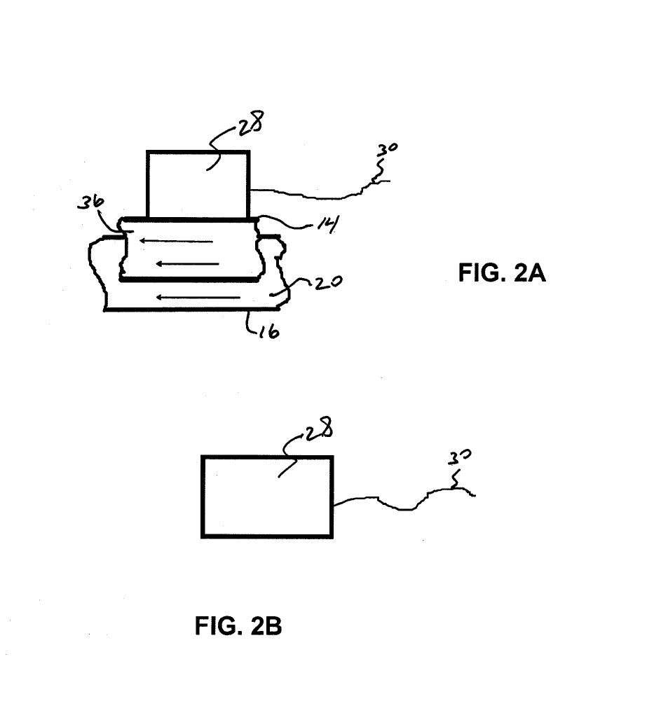

As shown in FIG. 1, a number of fire prevention sprinklers 12 are installed at various locations in the premises to be protected against fire. In addition to the normal fire sprinkler piping 14 (not illustrated in FIG. 1) that serves to deliver water (or another fire-extinguishing medium) to the sprinklers 12, a line (“warming medium path”) 16 is provided that distributes a warming medium, preferably water from a water supply 10, along or through the fire sprinkler piping and to each of the fire sprinklers 12. In this embodiment the warming medium path 16 is structured as a warming jacket for the fire sprinkler piping 14, that is, it is located adjacent to and thermally coupled to, and may at least partially surround the circumference of, that piping 14 (see FIG. 2A). A heat source 18 heats the warming medium 20 to an appropriate temperature, and a pump 22 serves to deliver the warmed medium to the sprinklers 12 via the warming medium path 16. The warming medium 20 is returned to its source via a return line 24.

Preferably, a thermostatic control 26 is located in the protected premises, and is coupled to actuate the heat source 18 and pump 22 as needed. It is particularly contemplated to actuate the pump 22 and heat source 18 to cause them to heat and distribute the warming medium 20 whenever the temperature in the premises falls to a certain level. For example, that level may be 50° F. (10° C.). In the illustrated example, when the temperature in the premises is measured as being below that value, the heat source 18 and pump 22 are actuated, and the warming medium 20—in this case, water—is heated to a higher temperature, such as 60° F. (about 15° C.), and circulated through the system to maintain the sprinklers 12 above freezing temperature.

The circulated warming medium 20 also warms the pipes 14 that supply water to the sprinklers 12, to ensure that those pipes 14 also do not freeze.

The thermostatic control 26 may utilize a thermometer 28 or equivalent device (see FIG. 2B) in the protected premises to measure the air temperature there, and to provide an electrical or other signal via wiring 30 or other means whenever the air temperature falls below the set level (50° F. or 10° C. in the above example). Alternatively, the thermometer 28 may provide periodic or continuous signals indicating the present air temperature, in which case the thermostatic control 26 may determine when the air temperature is below the set level.

In another approach, illustrated in FIG. 2A, the thermometer 28 or equivalent device may measure the temperature of the water or other fire extinguishing fluid 36 at one or more points in the sprinkler system, and transmit an electrical or other signal when the temperature of that water or other extinguishing fluid falls below a set temperature (it should be noted that the arrows in FIG. 2A do not necessarily indicate the direction of flow of either fluid, and should not be understood as meaning that both fluids are in motion at one time).

A higher or lower value for the premises temperature can be used to determine when the system is to be activated, and could in principle be any desired temperature that is sufficiently above 40° F. (about 4° C.) to provide certainty that the sprinklers 12 and the pipes 14 that supply them will not freeze. Similarly, the temperature to which the warming medium 20 is heated need not be 60° F., although it is believed that this temperature is a favorable one in terms of ensuring that the sprinkler system will not freeze, while not requiring excessive energy or cost to heat the medium beyond what is necessary.

As mentioned, radiant heating is preferred as the active heat source 18, but other heat sources may be used instead, including water heaters, geo-thermal devices, boilers, and other types of known heat transfer equipment.

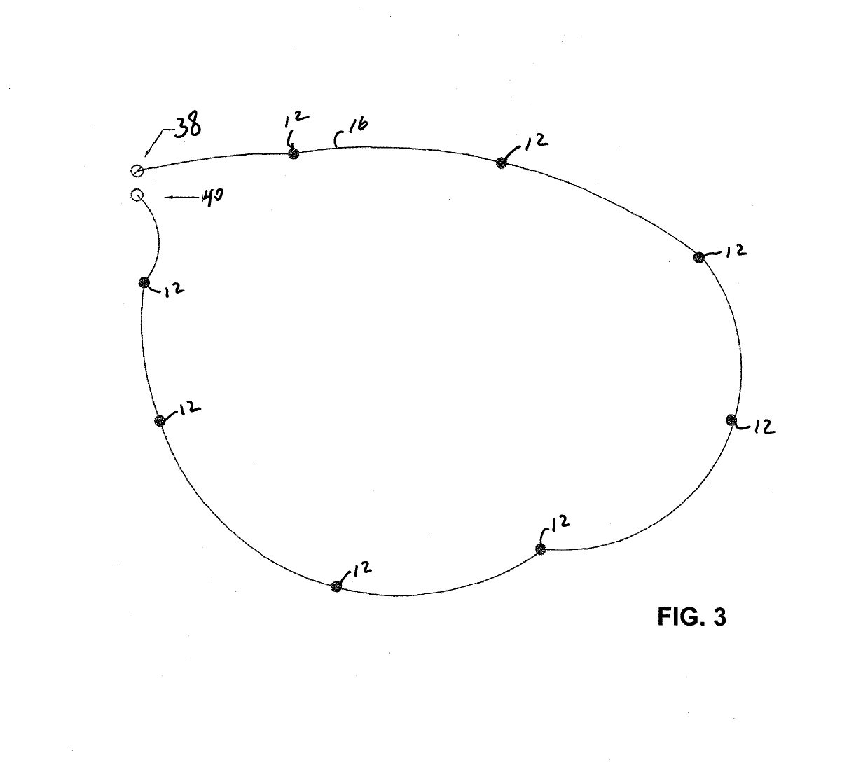

As an alternative to an active heat source, it is also contemplated to use a passive system for providing heat to the warming medium. In such a system, illustrated in FIG. 3, a number of fire prevention sprinklers 12 are installed at various locations in the unheated portion of the premises to be protected against fire, and a line is provided as a warming medium path 16 to distribute the warming medium 20, preferably water, along or through the fire sprinkler piping 14 and to each of the fire sprinklers 12 as in the embodiment of FIG. 1. This warming medium path 16 is arranged to pass at point 38 into a heated portion of the premises, to be warmed there, and then passes at 40 back into the unheated portion of the premises and circulates the warming medium 20 to the sprinklers 12. The warming medium path 16 in the unheated portion may be made of cross-linked polyethylene (“PEX”) as one suitable material, although other materials may be used instead.

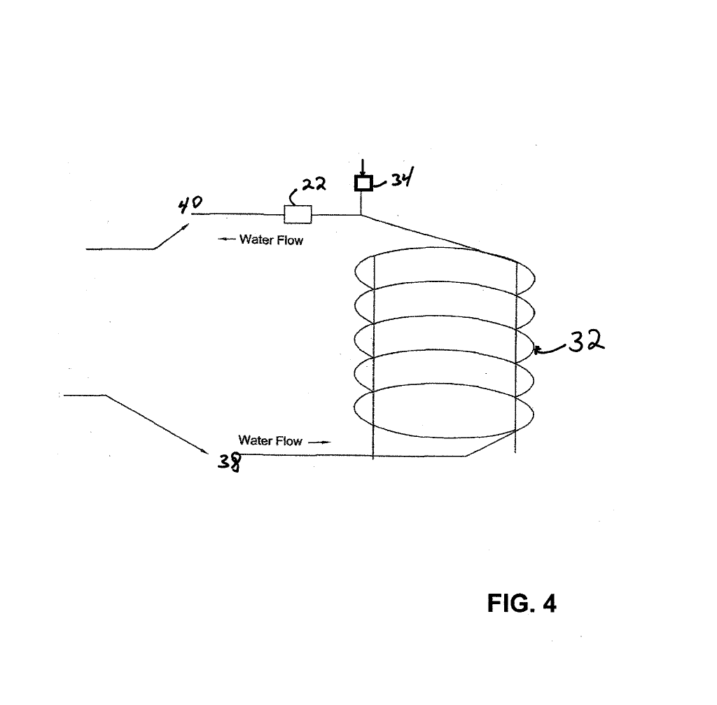

FIG. 4 illustrates another portion of the embodiment of FIG. 3. The warming medium path passes from the unheated premises (which may for example be the attic of a residence, or an unheated portion of other types of premises), and is formed as a spiral 32 through which the warming medium 20 circulates before passing through a circulating pump 22 back into the unheated portion of the premises shown in FIG. 3. The spiral or helix 32 may be positioned surrounding a portion of the piping of the heating system or the hot-water supply system of the premises, as two examples.

The domestic water supply may be the source of water to be used as the warming medium, via check valve 34; this is also the case with the embodiment of FIG. 1.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

Further, the purpose of the accompanying Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure provided herein. The Abstract is not intended to be limiting as to the scope of the example embodiments presented herein in any way.

What is claimed is:

1. A fire prevention sprinkler system, comprising:
a plurality of fire prevention sprinklers installed at various locations in premises to be protected against fire;
piping connected to supply water or another fire-extinguishing medium to said sprinklers;
a warming medium path arranged to distribute a warming medium to warm said piping and to said fire sprinklers;
a heat source located to heat the warming medium to a desired temperature; and
a pump system arranged to deliver the warming medium through said warming medium path.

2. The system of claim 1, further comprising a return line for returning the warming medium from said sprinklers to said pump system and/or said heat source.

3. The system of claim 1, further comprising a thermostatic control connected to said heat source and said pump, to cause said heat source and said pump to heat and distribute the warming medium whenever a measured temperature falls below a predetermined threshold value.

4. The system of claim 3, wherein said thermostatic control includes a thermometer arranged to measure the air temperature in the protected premises, as the measured temperature.

5. The system of claim 3, wherein said thermostatic control includes a thermometer arranged to measure the temperature of liquid in said piping, as the measured temperature.

6. The system of claim 1, wherein said heat source includes a radiant heating source arranged to heat the warming medium.

7. The system of claim 1, wherein said warming medium path includes a portion located in a heated area of the premises, said portion receiving heat from the air in the heated area of the premises.

8. The system of claim 7, wherein said portion of said warming medium path comprises PEX.

9. The system of claim 1, wherein said warming medium path includes a portion located in a heated area of the premises, said portion being thermally coupled to a heating conduit or a hot-water conduit or both, to receive heat from the heating conduit and/or the hot-water conduit.

10. The system of claim 9, wherein said portion of said warming medium path comprises PEX.

11. The system of claim 1, further comprising a connection to a water supply of the premises, wherein water from that water supply is used as the warming medium.
